(19) United States
(12) Patent Application Publication
(10) Pub. No.: US 2009/0045591 A1
(43) Pub. Date: Feb. 19, 2009

(54) Device for Leakproof Connection of Telecommunication Cables and Production Method Thereof

(75) Inventors: Jean-Marc Cailleaux, Lannion (FR); Bernard Cahuzac, Montpellier (FR)

Correspondence Address: COHEN, PONTANI, LIEBERMAN & PAVANE LLP, 551 FIFTH AVENUE, SUITE 1210, NEW YORK, NY, 10176, US

(73) Assignee: France Telecom, Paris (FR)

(21) Appl. No.: 11/794,343

(22) PCT Filed: Jan. 2, 2006
(86) PCT No.: PCT/FR06/50001

§ 371 Date: Mar. 21, 2008

(30) Foreign Application Priority Data
Jan. 4, 2005 (FR) 0500030

(51) Int. Cl. H02G 15/013; F16C 1/26

(52) U.S. Cl. 277/617; 403/269

(57) ABSTRACT

A sealed connection device (18) for telecommunications cables comprises a tubular plug (20) for being received in an inlet of a protective box for telecommunications, with a plurality of tubes (22) each designed to receive at least one telecommunications cable (34). The tubes (22) are disposed longitudinally in the plug (20) so as to pass right through it, and a resin (28) is cast between the tubes (22) so as to provide both mechanical retention of the tubes in the plug and sealing of the connection device.

### BACKGROUND OF THE INVENTION

The present invention relates to the general field of telecommunications. It relates more particularly to a device for sealed connection of telecommunications cables, for example optical fibers, the device being for use in a protective box used for distribution lines.

The optical fiber cables that are used to construct telecommunications lines are connected by means of connectors and splices. In order to protect them from moisture and other ambient agents (oils, acids, or other pollutants), cable ends and connectors are generally placed in sealed protective boxes which are themselves placed in telecommunications structures (underground chambers, cabinets, raceways, etc.).

Such protective boxes, which are generally tubular or parallelepipedal in shape, present inlets that are usually situated in two opposite faces. These inlets need to be thoroughly sealed, both with respect to their own closure devices and with respect to their cable inlets.

Furthermore, the cable inlets of such boxes are bulky because they are constituted by tubular plugs that are leaktight and strong. The number thereof must therefore limited for any one box. Thus, for a protective box dedicated to optical fiber cables, the maximum number of inlets is generally of the order of six to 12, for 100 to 200 spliced optical fibers. This number of cable inlets is sufficient for transport links where the cable division ratio is small (of the order of 2 to 3 at most).

In contrast, with a distribution optical network, it is frequently necessary to serve a large number of users from a single point. Thus, there exists a network architecture known as a passive optical network (PON) that consists in separating a single optical fiber by means of a coupler into eight, 16, or 32 optical fibers in order to serve a corresponding number of users, thereby exponentially increasing the number of cable inlets that are needed.

Document EP 0 695 900 provides for dividing a cable inlet having a diameter of 20 millimeters (mm) into two or four inlets each having a diameter of 3 mm to 4 mm. The protective box that initially had six cable inlets can then be transformed into a box presenting a large-diameter inlet enabling a large-diameter cable to be subdivided into 20 small cables.

Not only do the cable inlets of that document fail to achieve cable densification that is sufficient for an application to an distribution optical network, they also present the drawback of being interdependent. Thus, when it is necessary to act on one of those inlets (to install or replace a cable), the other inlets are also involved. In particular, the elastomer washers that provide sealing for one inlet are common to all of the inlets, so that any operation on one of them breaks sealing on all of them. They also present the drawback of retaining cables only weakly in the elastomer washers.

### OBJECT AND SUMMARY OF THE INVENTION

A main object of the present invention is thus to mitigate such drawbacks by proposing a device for sealed connection of telecommunications cables that enables cable density for a given protective box volume to be increased significantly, while conserving independence between the cable inlets.

To this end, the invention provides a sealed connection device for telecommunications cables, the device comprising a tubular plug for being received in an inlet of a protective box for telecommunications, and a plurality of tubes each designed to receive at least one telecommunications cable, said tubes being disposed longitudinally in the plug so as to pass right through it, the device being characterized in that it further comprises a resin that is cast between the tubes so as to ensure both mechanical retention of the tubes in the plug and sealing of the connection device.

The use of a plurality of tubes housed in the plug makes it possible to increase cable density significantly. For example, a single plug can receive as many 36 tubes, i.e. at least as many telecommunications cables. It is possible to make such connection devices independent firstly because each plug that is to be received in an inlet of a protective box presents its own sealing, and secondly because the cables are placed in the tubes without slack and without interfering with the sealing that exists between the tubes or between the tubes and the cables already in place.

Furthermore, such a connection device presents reliability (in terms of mechanical strength, leaktightness, and ability to withstand pollutants) that is well adapted to the environment of a protective box for telecommunications.

Another advantage of such a connection device is that it is possible to conserve existing boxes in the same conditions of use, thereby enabling costs to be kept down, in particular in terms of training staff.

According to an advantageous disposition of the invention, the plug includes a reduction in section at an inlet end so as to prevent the tubes from moving longitudinally in the plug.

According to another advantageous disposition of the invention, the plug has at least two distinct annular compartments, each designed to have a plurality of tubes passing therethrough.

The invention also provides a method of manufacturing such a connection device. The method is characterized in that it consists: in using a tubular plug designed to be received in an inlet of a protective box for telecommunications; in using a plurality of tubes each designed to receive at least one telecommunications cable; in disposing the tubes longitudinally in the plug so that the tubes pass right through the plug; and in casting a resin between the tubes in such a manner as to ensure both mechanical retention of the tubes in the plug and sealing of the connection device.

The resin may be cast into the plug via an injection tube that opens out between the tubes. Under such circumstances, the tubes are advantageously spaced apart from one another by means of rings so as to facilitate distribution of the resin while it is being cast.

### BRIEF DESCRIPTION OF THE DRAWINGS

Other characteristics and advantages of the present invention appear from the following description made with reference to the accompanying drawings which show an embodiment having no limiting character. In the figures:

FIG. 1 is a diagrammatic perspective view of a distribution box for receiving a connection device of the invention;

FIG. 2 is a partially cutaway view of a connection device of the invention; and

FIGS. 3 to 9 show various steps in the method of the invention for manufacturing the FIG. 2 connection device.

### DETAILED DESCRIPTION OF AN EMBODIMENT

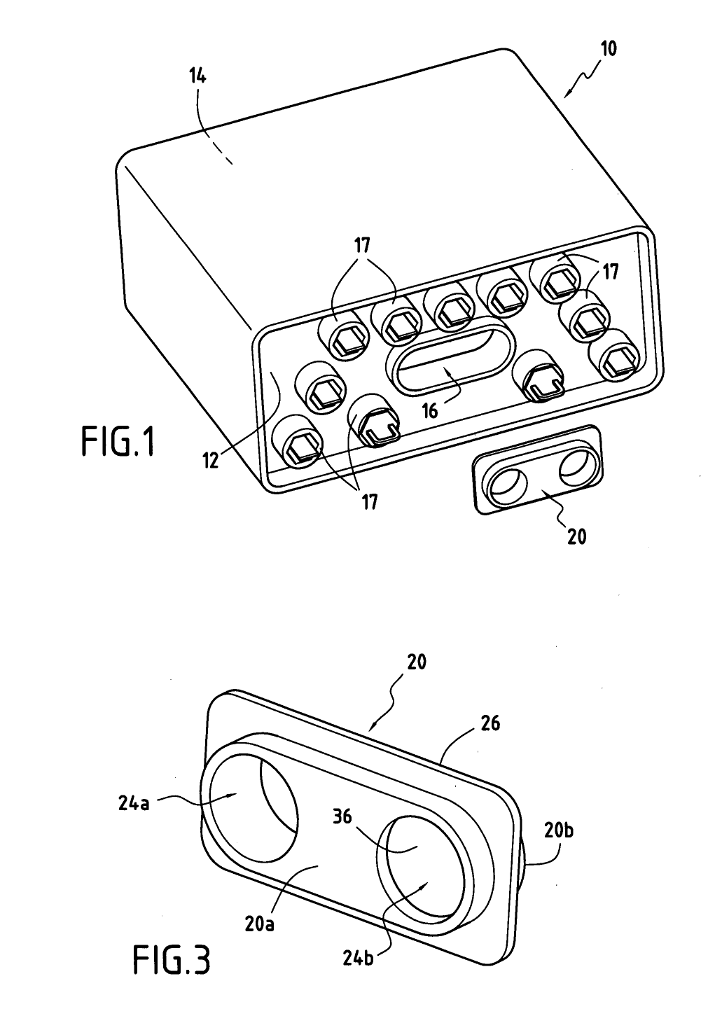

FIG. 1 is a diagrammatic view of a protective box 10 typically used in the terminal portion of a telecommunications network to serve a large number of users from a single point.

The box 10 is substantially in the form of a rectangular parallelepiped presenting at opposite ends an inlet face 12 and an outlet face 14. The inlet face 12 presents at least one inlet orifice 16 for passing optical fiber telecommunications cables.

Additional orifices 17 are also provided in the inlet face 12 of the box. These additional orifices 17 serve to enable single telecommunications cables to enter or leave the box.

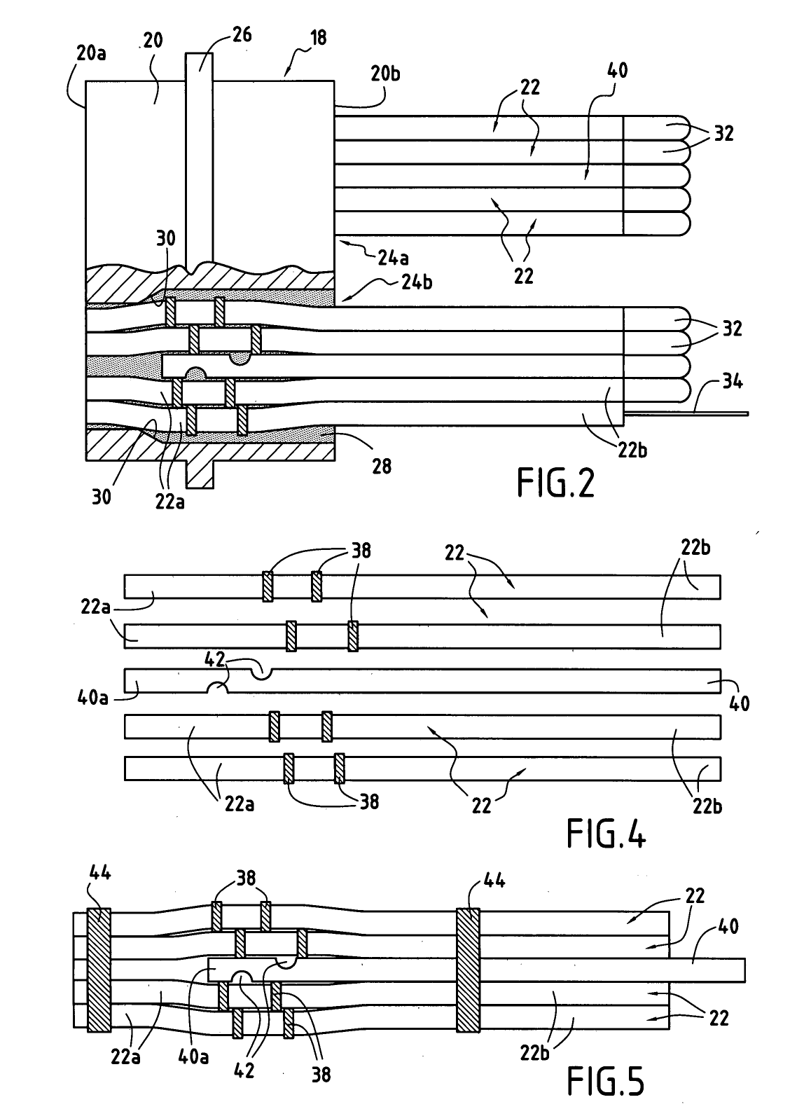

With reference to FIG. 2, a device 18 for sealed connection of telecommunications cables is designed to be housed in the inlet orifice 16 formed in the inlet face 12 of the box 10.

The connection device 18 of the invention comprises in particular a tubular plug 20 and a plurality of tubes 22 each serving to receive at least one telecommunications cable (also referred to as telecommunications cable transport tubes).

The tubular plug 20 presents an inlet wall 20a that is to be positioned in the protective box, and an outlet wall 20b that is opposite from its inlet wall 20a.

In the embodiment of FIG. 2, the plug 16 presents two annular compartments 24a and 24b which are distinct from each other. These compartments 24a and 24b pass right through the plug 20, each serving to receive a plurality of telecommunications cable transport tubes 22. The number of compartments could nevertheless be different.

The plug 20 is also provided with a flange 26 that comes to bear against the inlet face 12 of the protective box 10 when the connection device is mounted in the box.

The telecommunications cable transport tubes 22, e.g. presenting an inside diameter of 4 mm for an outside diameter of 6 mm, can be made of polyolefin or polyamide. They are disposed longitudinally in the compartments 24a, 24b of the plug 20 so as to pass right through it.

More precisely, at an inlet end 22a, each of the tubes 22 is flush with the inlet wall 20a of the plug 20. At its opposite end 22b (outlet end), each tube projects longitudinally from the outlet wall 20b of the plug 20.

The connection device 18 further comprises a resin 28 which is cast between the tubes 22 so as to serve firstly to hold the tubes mechanically in the plug 20 and secondly to provide the connection device with overall sealing.

The resin 28 is cast into each of the compartments 24a, 24b of the plug 20 between its inlet and outlet walls 20a and 20b. In order to ensure that the tubes 22 are held securely in the plug 20 with good sealing, the resin 28 is distributed between the tubes and between the tubes and the inside walls of the plug.

The resin may be of the single-component or two-component type. For example, it may be constituted by polyester or polyurethane. Its composition needs to comply with certain standards that are in force for protecting telecommunications cable splices. In particular, it must present a setting time that is relatively short.

In an advantageous disposition of the invention, the plug 20 has a reduction in section 30 in each of its compartments 24a, 24b at the inlet end thereof so as to prevent the tubes 22 from moving longitudinally in the plug.

Furthermore, at their outlet end 22b, the tubes 22 may have respective covers 32 serving to make the tubes leaktight in the absence of telecommunications cables.

When a cable 34 is inserted in a tube, its cover 32 is removed and sealing is provided, e.g. by means of a heat-shrink sleeve.

When not in use for installing a unit cable, the additional orifices 17 may also receive respective tubular plugs of the type described above, preferably plugs having a single compartment only.

A method of manufacturing such a connection device is described below with reference to FIGS. 3 to 9 that show various steps of the method.

FIG. 3 is a perspective view of an example of a plug 20 for use in manufacturing such a connection device. The plug 20 presents two compartments 24a and 24b for passing telecommunications cables.

In the absence of telecommunications cables, such a plug 20 is designed to close one of the inlet orifices of the protective box. For this purpose, each compartment 24a, 24b presents a wall 36 in the form of a capsule that can be removed, e.g. using a screwdriver and a hammer (only one wall 36 is shown in FIG. 3, the wall of compartment 24b).

With reference to FIG. 4, a plurality of tubes 22 (four tubes in FIG. 2) are provided for transporting telecommunications cables. These tubes 22 are spaced apart from one another by rings 38 secured to their inlet ends 22a. These rings 38 are disposed on the set of tubes in a staggered configuration in order to have the same spacing between all of the tubes (e.g. of the order of 1 mm). They also make it possible to provide spacing between the tubes and the inside walls of the plug compartments.

An injection tube 40 is also provided. This tube 40 enables resin to be injected into the compartments 24a, 24b using an operating technique described below. It is provided with a plurality of holes 42 at its inlet end 40a.

As shown in FIG. 5, the tubes 22 are arranged around the injection tube 40 and they are held in this position, e.g. by means of adhesive tapes 44 wound around their inlet and outlet ends 22a and 22b. It should be observed that the inlet end 40a of the injection tube 40 is disposed longitudinally so as to be set back a little relative to the tubes 22 so as to allow resin to be injected between the tubes.

These operations are repeated for each set of tubes 22, 40 that is to be housed in the compartments 24a, 24b of the plug 20.

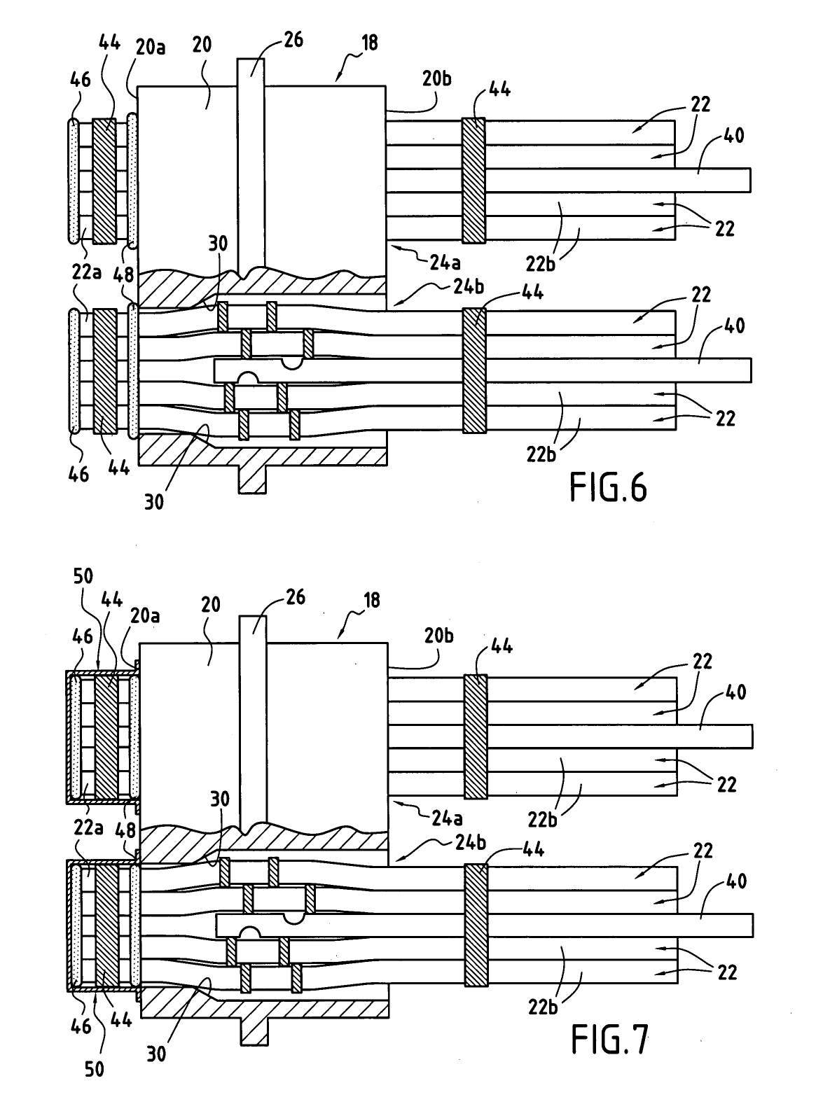

The following step (FIG. 6) consists in introducing the sets of tubes 22, 40 as prepared in this way longitudinally into the compartments 24a, 24b of the plug 20 in such a manner that the tubes pass right through the plug. The sets of tubes 22, 40 come into abutment against the reduction in section 30 provided at the inlet end of each compartment.

A sealing bead 46 (e.g. of butyl sealant) is then placed at the outlet ends 22a of the tubes 22 so as to close them. An additional sealing bead 48 may also be disposed around the tubes 22 against the inlet wall 20a of the plug 20.

A cap-forming endpiece 50 is then put into place around the outlet ends 22a of the tubes 22 (FIG. 7). Advantageously, this endpiece 50 comes to bear against the additional sealing bead 48 so as to ensure that the set of tubes is closed in thoroughly sealed manner. An adhesive tape (not shown) may be necessary for holding the endpiece in this position.

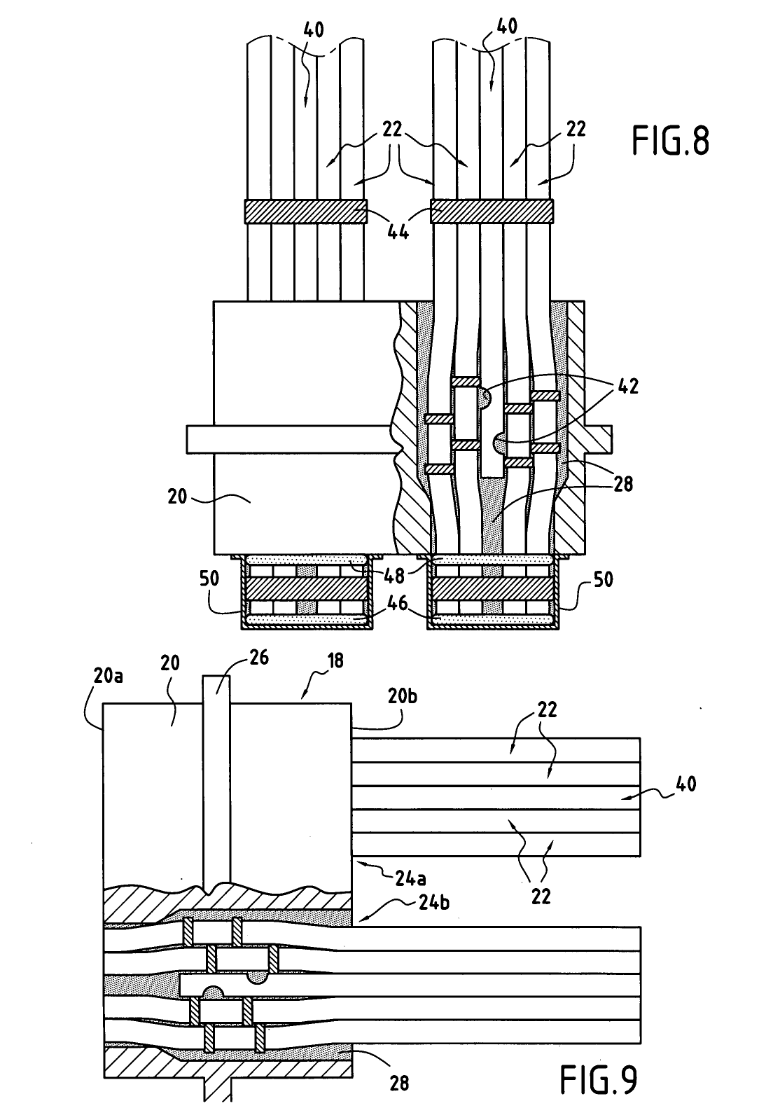

In order to make it easier to cast the resin, the plug 20 and the tubes 22 as positioned in this way are disposed vertically with the endpiece 50 pointing downwards. The resin 28 is then cast into the compartments 24a, 24b using the injection tubes 40 provided with the holes 42 (FIG. 8).

Once the resin 28 has polymerized, the endpieces 50 are withdrawn and the excess lengths of tube 22 projecting from the inlet wall 20a of the plug are cut off (e.g. by sawing) as shown in FIG. 9. The adhesive tapes are also withdrawn.

Beside this inlet wall 20a, after the ends of the tubes 22 have been cut, they are trimmed and smoothed. Beside the outlet wall 20b of the plug, the tubes 22, 40 can be cut to the same length.

Finally, as described with reference to FIG. 2, a sealing cover 32 can be disposed on the outlet end 22b, 40b of each of the tubes 22, 40 in the absence of a sealing cable.

1. A sealed connection device (18) for telecommunications cables, the device comprising a tubular plug (20) for being received in an inlet (16) of a protective box (10) for telecommunications, and a plurality of tubes (22) each designed to receive at least one telecommunications cable (34), said tubes (22) being disposed longitudinally in the plug (20) so as to pass right through it, the device being characterized in that it further comprises a resin (28) that is cast between the tubes (22) so as to ensure both mechanical retention of the tubes in the plug and sealing of the connection device.

2. A device according to claim 1, characterized in that the plug (20) includes a reduction in section (30) at an inlet end so as to prevent the tubes (22) from moving longitudinally in the plug.

3. A device according to claim 1, characterized in that the plug (20) has at least two distinct annular compartments (24a, 24b) each designed to have a plurality of tubes (22) passing therethrough.

4. A method of manufacturing a sealed connection device (18) for telecommunications cables, the method being characterized in that it consists:
in using a tubular plug (20) designed to be received in an inlet (16) of a protective box (10) for telecommunications;
in using a plurality of tubes (22) each designed to receive at least one telecommunications cable (34);
in disposing the tubes (22) longitudinally in the plug (20) so that the tubes pass right through the plug; and
in casting a resin (28) between the tubes (22) in such a manner as to ensure both mechanical retention of the tubes in the plug and sealing of the connection device.

5. A method according to claim 4, characterized in that the resin (28) is cast in the plug (20) via an injection tube (40) opening out between the tubes (22).

6. A method according to claim 5, characterized in that the tubes (22) are spaced apart from one another by rings (38) so as to facilitate the distribution of the resin (28) while it is being cast.

7. A device according to claim 2, characterized in that the plug (20) has at least two distinct annular compartments (24a, 24b) each designed to have a plurality of tubes (22) passing therethrough.
